(19) United States
(12) Patent Application Publication
(10) Pub. No.: US 2008/0052974 A1
(43) Pub. Date: Mar. 6, 2008

(54) SYSTEM FOR FUNCTION AND OUTPUT IDENTIFICATION OF A POWER SYSTEM CHASSIS AT A DISTANCE

(75) Inventors: Nicholas Teufel, Duncanville, TX (US); Khanh Q. Nguyen, Allen, TX (US)

Correspondence Address: HITT GAINES P.C., P.O. BOX 832570, RICHARDSON, TX, 75083, US

(73) Assignee: Tyco Electronics Power Systems, Inc. A Nevada Corporation, Mesquite, TX (US)

(21) Appl. No.: 11/849,822

(22) Filed: Sep. 4, 2007

Related U.S. Application Data
(60) Provisional application No. 60/824,562, filed on Sep. 5, 2006.

(51) Int. Cl. G09F 3/02

(52) U.S. Cl. 40/625

(57) ABSTRACT

Introduced is a power system chassis identification system. In one embodiment, the system includes: (1) a power system chassis rack holding a plurality of chassis, each housing a rectifier or a converter and (2) a label located on each chassis having symbols thereon identifying the chassis as housing a rectifier or a converter and its voltage input/output, which label is readable at a distance of not less than twenty feet.

### CROSS-REFERENCE TO RELATED APPLICATION

This Application claims the benefit of U.S. Provisional Application Ser. No. 60/824,562 filed Sep. 5, 2006, entitled “NE Logo Labels,” commonly assigned with the invention and incorporated herein by reference.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

The invention is directed, in general, to a power system chassis and more specifically, to an identification system for identifying a chassis as housing a converter or a rectifier and its output voltage rating.

### BACKGROUND OF THE INVENTION

The various components making up a power or energy system used for telecommunications applications are generally housed together in an equipment rack. Such a rack may have several rows of chassis, each housing an electronic device, arranged in stacks. At least one chassis in the rack will house a controller, while each of the remaining chassis will either house a rectifier or a converter. Each rectifier and converter will have a designated voltage power capacity, depending on its application.

A power system rack will, in most cases, be co-located with the electronic equipment for which it houses equipment supplying the necessary power. The number and type of chassis in the rack depends on the type of equipment being powered. Frequently, the variety of different types of electronic equipment being powered will require both AC and DC power of different voltages, which means that the types of chassis in the power system rack will vary as to type and power capacity.

As the physical size of rectifiers and converters has decreased over the years, the size of the chassis housing such devices has also become smaller. Consequently, the information portion on the chassis faceplate has also become smaller and more difficult to read, particularly at a distance. This poses an inconvenience for personnel working on electronic equipment who need to know the type and power rating of each converter and rectifier housed a rack. A maintenance person may have to physically move from equipment being worked on to the power system rack in order to read the print on each chassis faceplate to determine the type of electronic device housed by the chassis and its power rating.

Accordingly, what is needed in the art is a system for labeling a power system chassis as to type and voltage input/output that a person having normal vision can read at a distance of at least twenty feet under normal indoor lighting conditions.

### SUMMARY OF THE INVENTION

To address the above-discussed deficiencies of the prior art, the invention provides for an electronic chassis identification system. In one embodiment, the system includes: (1) a power system chassis rack holding a plurality of chassis, each housing a rectifier or a converter and (2) a label located on each chassis having symbols thereon identifying the chassis as housing a rectifier or a converter and its voltage input/output, which label is readable at a distance of not less than twenty feet.

In another aspect, the invention provides a chassis identification method for use with a power system. In one embodiment, the method includes: (1) locating a label readable at a distance of not less than twenty feet on each chassis housing a rectifier or a converter in a power system chassis rack and (2) causing symbols to be placed on each of said labels identifying said chassis as housing a rectifier or a converter together with a voltage input/output.

The foregoing has outlined certain aspects and embodiments of the invention so that those skilled in the art may better understand the detailed description of the invention that follows. Additional aspects and embodiments of the invention will be described hereinafter that form the subject of the claims of the invention. Those skilled in the art should appreciate that they can readily use the disclosed aspects and embodiments as a basis for designing or modifying other structures for carrying out the same purposes of the invention. Those skilled in the art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawings, in which:

FIGS. 1A-1C illustrate am isometric view of a chassis constructed in accordance with the invention for housing a converter or controller and a faceplate from the chassis;

FIGS. 2A and 2B illustrate a label used on a chassis housing a rectifier in accordance with the invention; and

FIGS. 3A and 3B illustrate a label on a chassis housing a converter used in accordance with the invention.

### -DETAILED DESCRIPTION

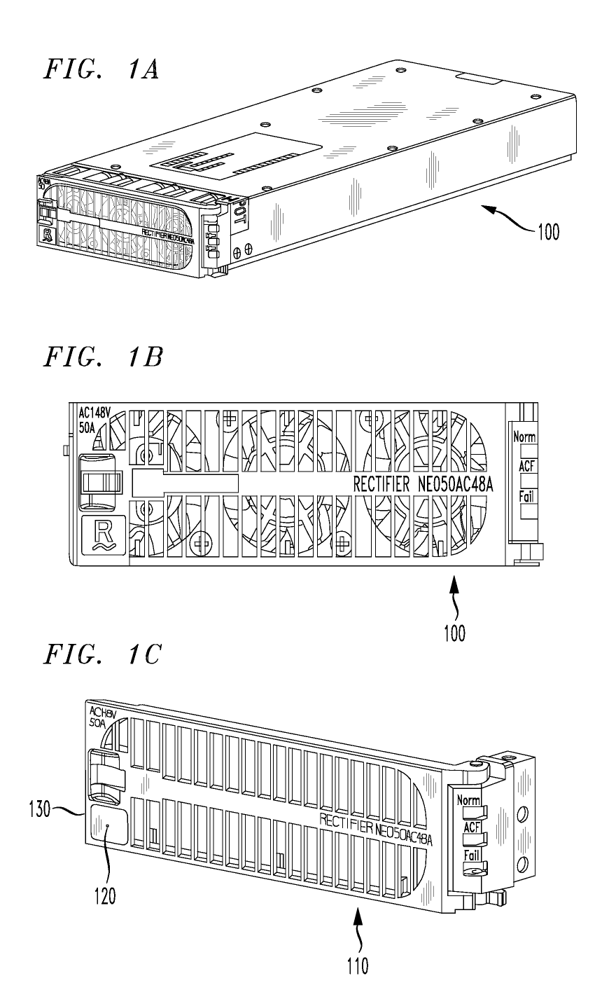

Referring initially to FIGS. 1A-1C, illustrated is an isometric view of a chassis 100 constructed in accordance with the invention used to house a converter or controller and a view of a faceplate 110 of such chassis 100. FIG. 1A shows an isometric view of a chassis 100 that can be used to house a rectifier or a converter. FIGS. 1B and 1C show the planar front and isometric frontal view of the faceplate 110 for such a chassis 100. The faceplate 110 shown in FIG. 1B is for a chassis 100 that is about 5.26 inches wide, 1.63 inches high and 13.85 inches deep.

Depending on the type and rating of electronic equipment being powered, a power system rack may contain several stacks of rectifier and/or converter chassis 100. To identify, in accordance with the invention, whether a particular chassis 100 houses a rectifier or a converter, the faceplate 110 has a recessed area 120 in which a label 130 can be placed. In one embodiment of the invention, the recessed area 120 is located in the lower left hand corner of the faceplate 110. A label 130 located in the recess must be readable at distance of not less than 20 feet by a user having normal (e.g., 20/20 or corrected to 20/20) vision under normal indoor lighting conditions (as diffuse incandescent or fluorescent light may provide). In one embodiment of the invention, the label 130 is about one-half an inch wide and one-half an inch tall.

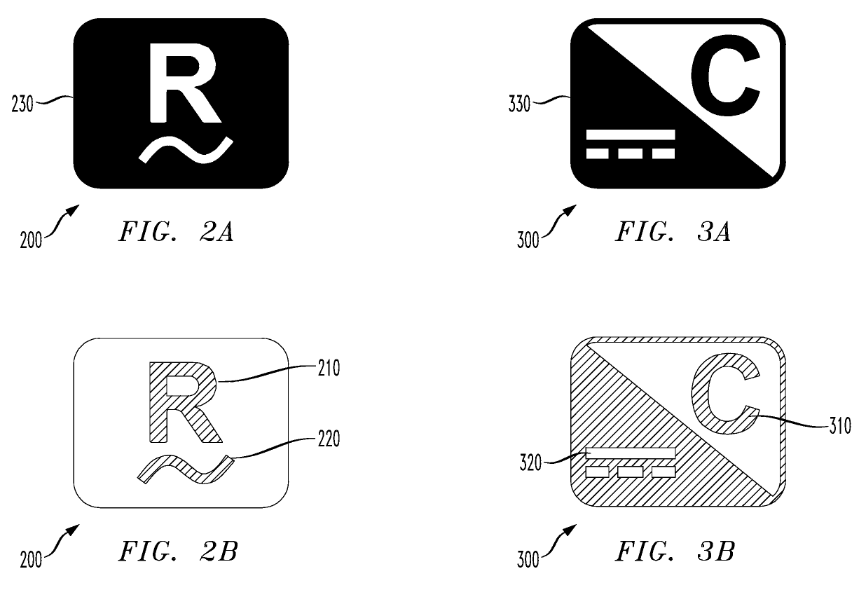

Turning now to FIGS. 2A and 2B illustrated are labels 130 for use on a chassis 100 housing a rectifier in accordance with the invention. The illustrated rectifier label 200 has the letter R thereon, designating it as a rectifier symbol 210 in accordance with the invention. It also has an alternating current symbol 220 co-located thereon.

In most cases, the rectifier symbol 210 and alternating current symbol 220 will be white in color against a colored background 230. The color of the background 230 is used to indicate the voltage input/output of the rectifier housed in the pertinent chassis 100. Those skilled in the pertinent art will understand that the color need not be a background 230 but can be any arrangement be readily identifiable by a person reading the label 210. In one embodiment of the invention, the voltage input/output for a rectifier will be selected from a group consisting of 12V, 24V and 48V. In another embodiment of the invention, a blue background 230 will be used to identify a rectifier having an input/output rating of 48V. In still another embodiment, a gold background 230 will be used to designate an input/output of 24V.

Turning now to FIGS. 3A and 3B illustrated are labels 130 for use on a chassis 100 housing a converter in accordance with the invention. The illustrated converter label 300 has the letter C thereon, designating it as a converter symbol 310 in accordance with the invention. It also has a direct current symbol 320 co-located thereon.

In most cases, the converter symbol 310 will be white in color and a predominant color 330 on the label will be used to indicate the voltage input/output of the converter chassis 100. Those skilled in the pertinent art will understand that the color can be any arrangement readily identifiable to a person reading the label 210 and still be within the intended scope of the invention. In one embodiment of the invention, the voltage input/output for a converter will be selected from a group consisting of 12V, 24V and 48V. In another embodiment of the invention, a blue background 330 is used to identify a converter having an input/output rating of 48V. In another embodiment, a gold background 230 is used to designate an input/output of 24V.

To withstand wear and tear, a Lexan® graphic film (commercially available from the General Electric Company of Fairfield, Conn.) having a thickness of about 10 mil may be used to make the rectifier label 200 and the converter label 300. To improve appearance, a velvet or gloss finish may be used for the Lexan® graphic film. For ease of installation, the rectifier 200 and converter label 300 may be provided with a 2 mil adhesive backing and a release paper liner. This will permit an assembler to remove the release paper liner and place an appropriate label 130 on each chassis 100 as either a rectifier or a controller device is installed in such chassis.

Although the invention has been described in detail, those skilled in the art should understand that they can make various changes, substitutions and alterations herein without departing from the scope of the invention in its broadest form.

What is claimed is:

1. An electronic chassis identification system, comprising:
a power system chassis rack holding a plurality of chassis, each housing a rectifier or a converter; and
a label located on each of said chassis having symbols thereon identifying said chassis as housing a rectifier or a converter and a voltage input/output, said label readable at a distance of not less than twenty feet.

2. The system as recited in claim 1 wherein each of said chassis includes a recess for locating said label.

3. The system as recited in claim 1 wherein each of said chassis housing a rectifier is identified by a label having the letter R and a symbol for alternating current located thereon.

4. The system as recited in claim 1 wherein each of said chassis housing a converter is identified by a label having the letter C and a symbol for direct current located thereon.

5. The system as recited in claim 1 wherein said label utilizes a color to identify said voltage input/output.

6. The system as recited in claim 5 wherein said voltage input/output is selected from the group consisting of 12V, 24V and 48V.

7. The system as recited in claim 5 wherein a blue color is used to designate a voltage input/output of 48 volts.

8. The system as recited in claim 5 wherein a gold color is used to designate a voltage input/output of 24V.

9. The system as recited in claim 1 wherein said label dimensions are less than about one-half of an inch wide and one-half of an inch high.

10. The system as recited in claim 1 wherein said label is located on the lower left corner of a faceplate on said chassis.

11. A chassis identification method for use with a power system, comprising:
locating a label readable at a distance of not less than twenty feet on each chassis housing a rectifier or a converter in a power system chassis rack; and
causing symbols to be placed on each of said labels identifying said chassis as housing a rectifier or a converter together with a voltage input/output.

12. The method as recited in claim 11 wherein each of said chassis includes a recess for locating said label.

13. The system as recited in claim 11 wherein each of said chassis housing a rectifier is identified by a label having the letter R and a symbol for alternating current located thereon.

14. The system as recited in claim 11 wherein each of said chassis housing a converter is identified by a label having the letter C and a symbol for direct current located thereon.

15. The system as recited in claim 11 wherein said label utilizes a color to identify said voltage input/output.

16. The system as recited in claim 15 wherein said voltage input/output is selected from the group consisting of 12V, 24V and 48V.

17. The system as recited in claim 15 wherein a blue color is used to designate a voltage input/output of 48 volts.

18. The system as recited in claim 15 wherein a gold color is used to designate a voltage input/output of 24V.

19. The system as recited in claim 11 wherein said label dimensions are less than about one-half of an inch wide and one-half of an inch high.

20. The system as recited in claim 11 wherein said label is located on the lower left corner of a faceplate on said chassis.
